(19) United States
(12) Patent Application Publication
(10) Pub. No.: US 2005/0042900 A1
(43) Pub. Date: Feb. 24, 2005

(54) Cable modem module unit and electronic unit

(75) Inventors: Shuji Abe, Kumagaya-shi (JP); Katsuya Kudo, Fukaya-shi (JP); Tsutomu Isoda, Takasaki-shi (JP); Masami Oosawa, Kumagaya-shi (JP); Mikine Fujihara, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/916,635

(22) Filed: Aug. 12, 2004

(30) Foreign Application Priority Data
Aug. 13, 2003 (JP) 2003-292971

(51) Int. Cl. H01R 12/00

(52) U.S. Cl. 439/76.1

(57) ABSTRACT

A cable modem module unit includes a tuner section configured to have an analog signal processing section for transmitting/receiving a high frequency signal, a digital signal processing section configured to perform digital processing on the signal input to and output from the tuner section, a shield case configured to hold the digital signal processing section and tuner section therein, and a terminal group configured to be connected at one end to the digital signal processing section and, at the other end, inserted into the shield case and extending outwardly to allow a digital signal to be input to, and output from, the digital signal processing section, the terminal group including a first terminal as part of the terminal group to allow a setting or checking to or for the digital signal processing section to be effected from outside the shield case.

### CROSS-REFERENCE TO RELATED APPLICATIONS

This application is based upon and claims the benefit of priority from prior Japanese Patent Application No. 2003-292971, filed Aug. 13, 2003, the entire contents of which are incorporated herein by reference.

### BACKGROUND OF THE INVENTION

1. Field of the Invention

The present invention relates to a cable modem module unit providing an interface to a network using, for example, a CATV (Cable Television) line. Further, the present invention relates to an electronic unit having the above-mentioned cable modem module unit incorporated therein.

2. Description of the Related Art

As well known in the art, a cable modem unit has been developed as an interface for connecting an electronic unit, such as a user's PC (Personal Computer), to a network using, for example, a CATV line. This cable modem unit is currently manufactured as an individual unit separate from the electronic unit, that is, as an independent unit directly handleable by the user.

Usually, the cable modem unit includes, on a back face, a RF (Radio Frequency) coaxial connector for connection to a CATV highway, an Ethernet connector, or jack, for connection to the PC and so on, a reset switch for resetting the unit back to an initial state, a power supply connector for receiving the power from a power supply, and so on.

Further, the cable modem unit includes, on a front face, a display section made of an LED (Light Emitting Diode), a liquid crystal, etc., and configured to display the supplying state of power, a state of connection to a central TV station, a state of connection to the PC, and so on, and a power supply switch for connecting or disconnecting a power supply to or from the unit, and so on.

The cable modem unit is currently held within a housing made of a synthetic resin and has its shape decided based on the circumstances under which it has to be installed, such as near the PC or be hung on the wall.

With the current continued advance toward a higher integration and higher performance of circuit component parts, as well as an improvement of the mounting technique, a higher demand is also made for a much lower, more compact and lightweight cable modem unit. From the standpoint of its size, it has been possible to house such a cable modem unit within a predetermined electronic unit.

Since, as set out above, the cable modem unit is constructed as an independent unit separate from any other electronic unit, various improvements are necessary in an attempt to incorporate it into a predetermined electronic unit. JPN PAT APPLN KOKAI PUBLICATION NO. 2002-16524 discloses a transmit/receive integral type high frequency unit including a receive-system block and transmit-system block in one housing. However, there is no description whatever about any structure where a housing with the reception-system block and transmit-system block formed thereon is built into a predetermined electronic unit.

### BRIEF SUMMARY OF THE INVENTION

According to one aspect of the present invention, there is provided a cable modem module unit comprising: a tuner section configured to have an analog signal processing section for transmitting/receiving a high frequency signal; a digital signal processing section configured to perform digital processing on the signal input to and output from the tuner section; a shield case configured to hold the digital signal processing section and tuner section therein; and a terminal group configured to be connected at one end to the digital signal processing section and, at the other end, inserted into the shield case and extending outwardly to allow a digital signal to be input to, and output from, the digital signal processing section, the terminal group including a first terminal as part of the terminal group to allow a setting or checking to or for the digital signal processing section to be effected from outside the shield case.

According to another aspect of the present invention, there is provided an electronic unit comprising: a cable modem module unit comprising a tuner section configured to have an analog signal processing section for transmitting/receiving a high frequency signal, a digital signal processing section configured to perform digital processing on a signal input to and output from the tuner section, a shield case configured to hold the digital signal processing section and tuner section therein, and a terminal group configured to be connected at one end to the digital signal processing section and, at the other end, inserted into the shield case and extending outwardly to allow a digital signal to be input to, and output from, the digital signal processing section, the terminal group including a first terminal as part of the terminal group to allow a setting and checking to and for the digital signal processing section to be effected from outside the digital signal processing section; and a power supply section configured to supply power to the cable modem module unit; the cable modem module unit is operated with the use of the power from the power supply section.

### BRIEF DESCRIPTION OF THE SEVERAL VIEWS OF THE DRAWING

FIG. 1 is a view showing one embodiment of the present invention illustrated for explaining a schematic arrangement of a CATV broadcasting system;

FIG. 2 is a perspective view showing a structure of a CATV terminal unit in the CATV broadcasting system;

FIG. 3 is a block diagram for explaining an outline of signal processing in the CATV terminal unit;

FIG. 4 is a block diagram shown for explaining a signal processing system of a cable modem module unit incorporated in the CATV terminal unit;

FIG. 5 is an exploded perspective view shown for explaining a structure of the cable modem module unit;

FIG. 6 is a plan view shown for explaining an arrangement of respective circuit component parts in the cable modem module unit;

FIG. 7 is an exploded perspective view shown for explaining another example of the mounting positions of a terminal group in the cable modem module unit;

FIG. 8 is an exploded perspective view shown for explaining a further example of the mounting positions of a terminal group in the cable modem module unit;

FIG. 9 is a perspective view shown for explaining a structure of a game machine with the cable modem module unit incorporated therein;

FIG. 10 is a block diagram shown for explaining a signal processing system in the game machine;

FIG. 11 is a block diagram shown for explaining a signal processing system of a cable modem module unit in another embodiment of the present invention; and

FIG. 12 is a perspective view shown for explaining a main structure of the game machine with the cable modem module unit incorporated therein.

### DETAILED DESCRIPTION OF THE INVENTION

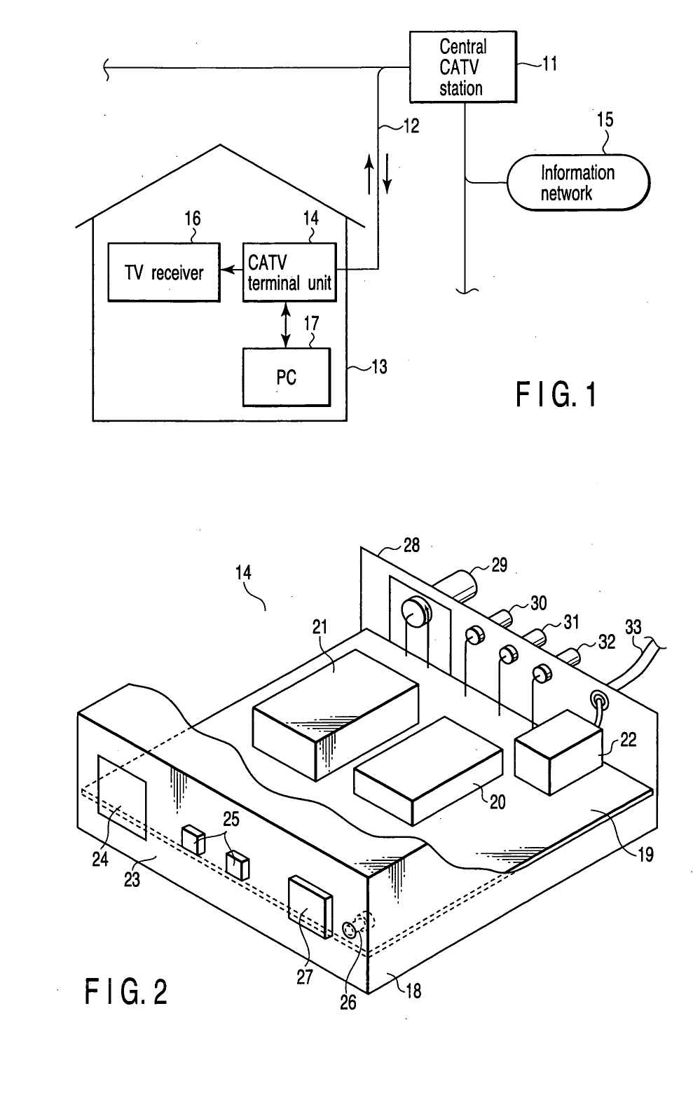

An explanation will be made in more detail below about one embodiment of the present invention. FIG. 1 shows a schematic arrangement of a CATV broadcasting system as will be explained in connection with this embodiment. In FIG. 1, reference numeral 11 shows a central CATV station.

The central CATV station 11 is connected through a CATV cable 12 to a CATV terminal unit 14 which is installed at each subscriber's home 13. Further, the central CATV station 11 is connected to various kinds of information networks 15 such as the Internet.

The CATV terminal unit 14 has the function of performing channel selection processing on various kinds of programs distributed from the central CATV station 11, performing demodulation processing, etc., on various kinds of information, such as video, audio and character information, from any channel-selected program. The various kinds of information, such as video, audio and character information, demodulated at the CATV terminal unit 14 are output to a TV receiver 16 for an audio-visual use on the user side.

The CATV terminal unit 14 is connectable to the PC 17 and has a cable modem function of conducting data communication with various kinds of information networks 15 via the central CATV station 11.

The various kinds of information, such as video, audio, character and PC data, are distributed from the central CATV station 11 to the CATV terminal unit 14 with the use of a “down” signal of a high frequency of, for example, about 90 to 860 MHz. From the CATV terminal unit 14 to the central CATV station 11, information is transmitted with the use of, for example, an “up” signal of a high frequency of, for example, about 5 to 65 MHz.

FIG. 2 is a view diagrammatically showing a structure of the CATV terminal unit 14. The CATV terminal unit 14 has a substantially box-like housing 18 and a main circuit board 19 is held within the housing 18 and has various kinds of circuit component parts.

That is, on the main circuit board 19 are mainly provided a broadcasting signal demodulation section 20 for performing channel selection processing, demodulation processing, etc., on various kinds of programs distributed from the central CATV station 11, a cable modem module unit 21 for conducting data communication with the various kinds of information networks 15 via the central CATV station 11, and a power supply section 22 for receiving a commercial AC (Alternating Current) and supplying necessary power to the broadcasting signal demodulation section 20 and cable modem module unit 21.

On a front panel 23 of the housing 18 are provided, for example, a display section 24 for displaying a state of connection to a reception channel, central CATV station 11, etc.; various kinds of operation elements 25 including a power supply switch; a display section 26 for displaying an ON or OFF state of a power supply section; a reception section 27 for receiving operation information from a remote controller not shown; and so on.

On a rear panel 28 of the housing 18 are provided, for example, a RF coaxial connector 29 for connection to the above-mentioned CATV cable 12; video and audio output terminals 30 and 31 for allowing video and audio signals which are demodulated at the above-mentioned broadcasting signal demodulation section 20 to be output to an external TV receiver 16, etc.; a connector 32 for the connection of information terminal (such as the PC 17) for access to various kinds of information networks 15 via the central CATV station 11; and AC line 33 for supplying commercial AC power to the above-mentioned power supply section; and so on.

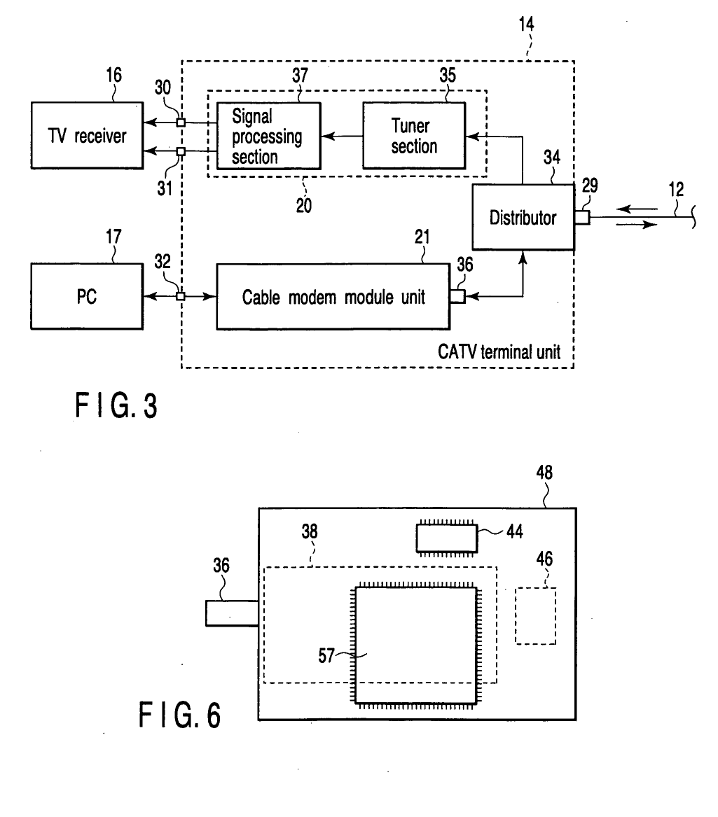

FIG. 3 shows an outline of signal processing at the above-mentioned CATV terminal unit 14. That is, the RF coaxial connector 29 for the connection of the above-mentioned CATV cable 12 is connected to a distributor 34. This distributor 34 has the function of connecting the CATV cable 12 to a tuner section 35 in the above-mentioned broadcasting signal demodulation section 20 and to the RF coaxial connector 36 in the above-mentioned cable modem module unit 21.

By doing so, various kinds of programs distributed from the central CATV station 11, after being supplied to the tuner section 35 via the CATV cable 12, RF coaxial connector 29 and distributor 34 and being channel selected, are demodulated into video and audio signals by means of a signal processing section 37 in the broadcasting signal demodulation section 20.

The video and audio signals which are demodulated at the broadcasting signal demodulation section 20 are output to an external TV receiver 16, etc., for an audio-visual use on the user side.

The access information from the PC 17 is sent to a corresponding information network 15 through a connector 32, cable modem module unit 21, RF coaxial connector 36, distributor 34, RF axial connector 29, CATV cable 12 and central CATV station 11.

The response information from the information network 15 is received by the PC 17 through the central CATV station 11, CATV cable 12, RF coaxial connector 29, distributor 34, RF coaxial connector 36, cable modem module unit 21 and connector 32.

That is, the above-mentioned cable modem module unit 21 has the function of, for example, controlling communication with the central CATV station 11, generating an “up” signal which is sent to the central CATV station 11, demodulating a “down” signal which is sent from the central CATV station 11, and controlling data communication with any external device (in this case, PC 17) connected to the cable modem module unit 21.

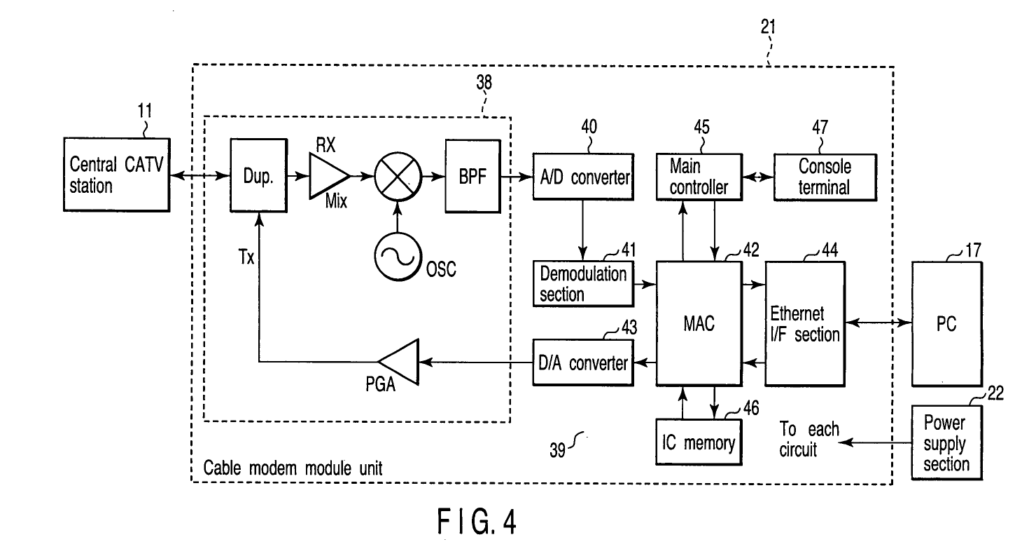

FIG. 4 shows a signal processing system of the cable modem module unit 21. This cable modem module unit 21 includes a tuner section 38 having an analog signal processing section for handling a high frequency signal transmitted to, and received from, the central CATV station 11 through the RF coaxial connector 36 and a digital signal processing section 39 for performing digital processing on a signal input to, and output from, the tuner section 38.

The digital signal processing section 39 includes an A/D (Analog/Digital) converter 40 for converting an analog “down” signal which has been output as a frequency converted signal in the tuner section 38 to a digital signal and a demodulation section 41 for demodulating the “down” signal of that digital signal to a data form, and the “down” signal of that data form is supplied to an MAC (Media Access Control) section 42.

A digital “up” signal generated in the MAC section 42 is converted by a D/A (Digital/Analog) converter 43 to an analog signal and sent via the tuner section 38 to the central CATV station 11.

Further, the MAC section 42 is connected to an external device (in this case, PC 17) connected via an Ethernet I/F (Interface) section 44 to the cable modem module unit 21 and has the function of communicating with the PC 17 with the use of data transmitted to, and received from, the central CATV station 11.

Further, the digital signal processing section 39 is such that, in order to generally control the operations of associated circuit component parts including the tuner section 38, it includes a main controller 45 with a microcomputer, etc., incorporated therein and an IC (Integrated Circuit) memory 46. The main controller 45 and IC memory 46 are connected to the MAC section 42.

A power supply section 22 is arranged outside the cable modem module unit 21 and supplies power to respective circuit component parts at the tuner section 38 and digital signal processing section 39 in the cable modem module unit 21.

To the above-mentioned main controller 45 is connected a console terminal 47. To the console terminal 47 is connected a control device, such as the PC. The console terminal provides a communication terminal for allowing communication to be conducted between the control device and the microcomputer in the main controller 45.

In this way, the control device allows communication to be conducted with the microcomputer of the main controller 45 via the console terminal 47 and allows the settings of various kinds of states in the cable modem unit 21, that is, the digital signal processing unit 39 as well as their checkings, etc., to be made.

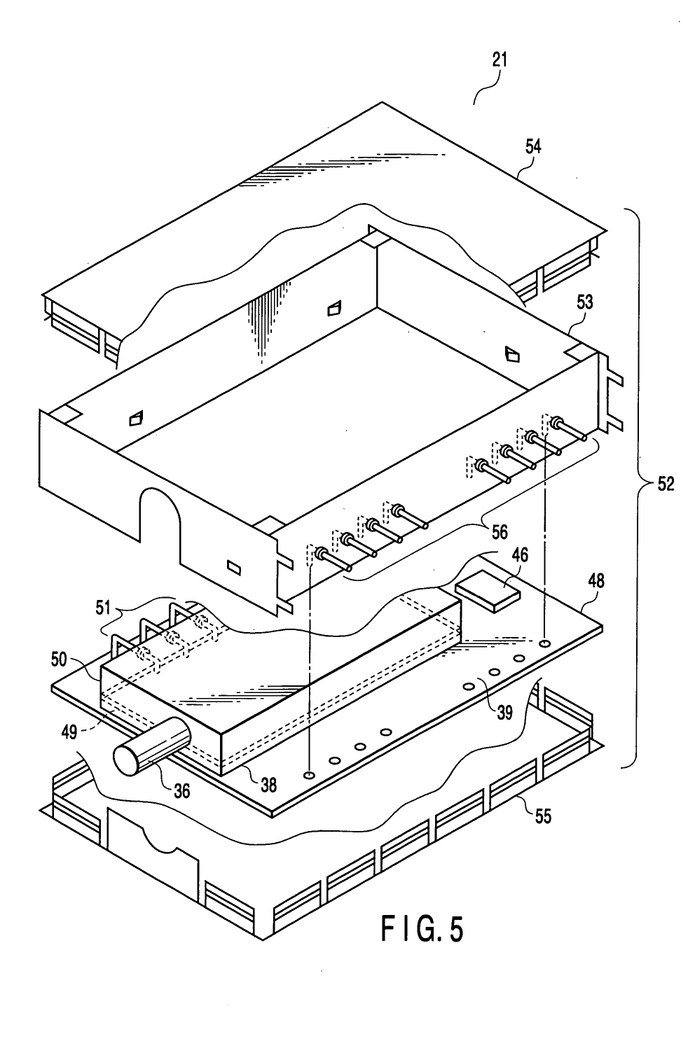

FIG. 5 shows a structure of the cable modem module unit 21. In FIG. 5, reference numeral 48 shows a circuit board where the tuner section 38 and digital signal processing section 39 shown in FIG. 4 are mounted.

It is to be noted that, in FIG. 5, the IC memory 46 in the digital signal processing section 39 is seen in such a state as to be connected to the circuit board 48.

Of these, the tuner section 38 has its RF coaxial connector 36 installed on the tuner circuit board 49 and provides the analog signal processing section. With the RF coaxial connector 36 exposed, the tuner circuit board 49 is held in place in a shield case 50 made of a material, such as a metal, having such an effect as to shield any spurious radiation of an electromagnetic wave.

The tuner section 38 is connected at one end to the tuner circuit board 49 and equipped at the other end with an analog signal inputting/outputting terminal group 51 externally extending through the shield case 50. By connecting the other end side of the terminal group 51 to the circuit board 48, the tuner section 38 is connected to the digital signal processing section 39 mounted on the printed circuit board 48.

The above-mentioned cable modem module unit 21 is so constructed that the surrounding area of the circuit board 48 with the tuner section 38 and digital signal processing section 39 mounted thereon is covered with a substantially hexahedral box-like shield case 52, or a case similar thereto, having the function of shielding any external electromagnetic wave.

This shield case 52 comprises a frame-like metal case 53 covering surrounding four faces of the circuit board 48, a first cover 54 covering one opening of this tetrahedral metal case 53 and a second cover 55 covering the other opening of the metal case 53.

Here, the metal case 53 includes a terminal group 56 for electrical connection between the outside of the cable modem module unit 21 and the digital signal processing section 39 on the circuit board 48 and for supplying power from the outside of the cable modem module unit 21 to various kinds of respective circuits on the circuit board 48.

As the terminal group 56 use is made of those terminals, such as through-connection capacitors and so on, extending through the metal case 53 and directly solderable to any other external circuit board (in this case, the main circuit board 19) or those terminals connectable by connectors of a simpler structure. The terminal group 56 is connected at each one end to the circuit board 48 and, at the other end side, externally extends through the metal case 53 and is connected to, for example, the main circuit board 19.

FIG. 6 shows a surface side opposite to that surface side of the circuit board 48 where the tuner section 38 is mounted. On this surface side are mounted a semiconductor chip 57 having an IC-form of an A/D converter 40, demodulation section 41, MAC section 42, D/A converter 43, main controller section 45 and so on, as well as an IC form of an Ethernet I/F section 44.

Here, it is to be noted that as part of the terminal group 56 provided on the metal case 53 the console terminal 47 is included. Even with the circuit board 48 in a state held in the shield case 52, the control device such as the PC is connected from the outside of the shield case 52 to the terminal corresponding to the console terminal 47 in the terminal group 56 and, by doing so, communication is conducted with the microcomputer of the main controller 45 so as to enable the settings of various kinds of states in the cable modem module unit 21 as well as their checkings to be made.

Incidentally, the console terminal 47 is used only under a situation in which the settings of various kinds of states in the cable modem module unit 21 as well as their checkings, etc., are made with the cable modem module unit 21 incorporated therein at the time of manufacture of the cable modem module unit per se and at the time of manufacture of the CATV terminal unit 14, that is, the console terminal 47 is intended not to be used normally on the user side.

In this case, the console terminal 47 is exposed as part of the terminal group 56 to an outside of the cable modem module unit 21 and, since the cable modem module unit 21 per se is incorporated within the housing 18 of the CATV terminal unit 14, the user is prevented from accessing the microcomputer of the main controller 45 through the console terminal 47.

Since the console terminal 47 is included as part of the terminal group 56, even if the cable modem module unit 21 is incorporated into the CATV terminal unit 14, access can be gained through the console terminal 47 to the microcomputer of the main controller 45 if the CATV terminal unit is pre-housed into the housing 18.

Even during the manufacturing process of the CATV terminal unit 14, therefore, it is possible to effect the settings in the cable modem module unit 21, their checkings, etc., and a resultant structure is suited to being incorporated into a predetermined electronic unit.

Further, even if the CATV terminal unit 14 has been completed, any qualified service personnel and engineer can detach the housing 18 from the CATV terminal unit 14 at a time of servicing, repairing, maintenance, etc., and, by doing so, it is possible to readily effect the settings, checkings, etc., in the cable modem module unit 21.

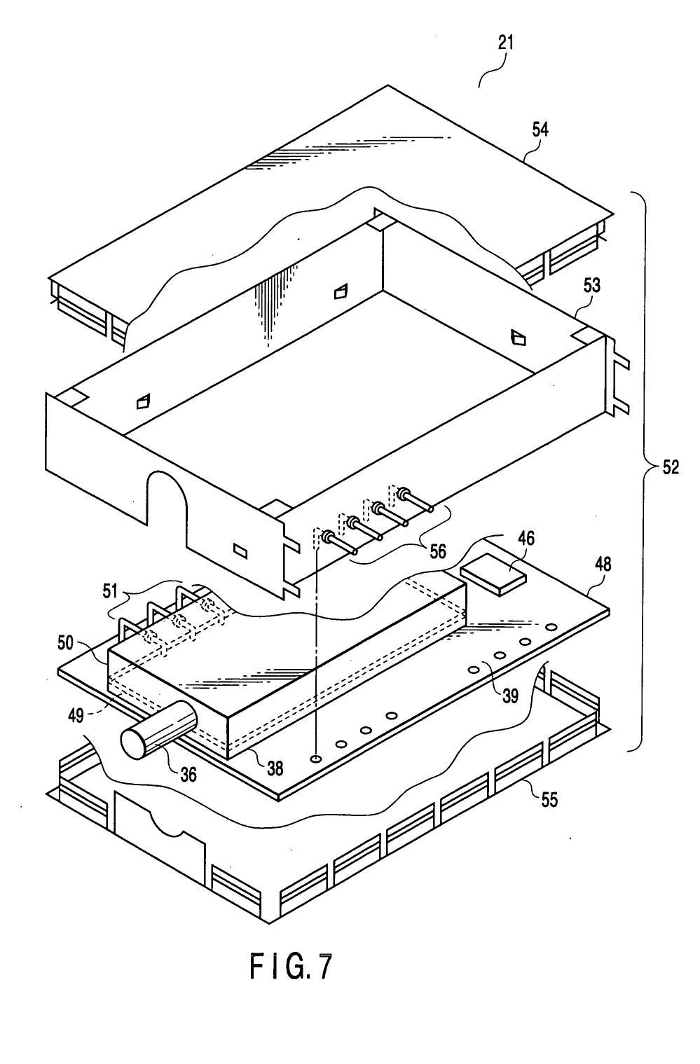

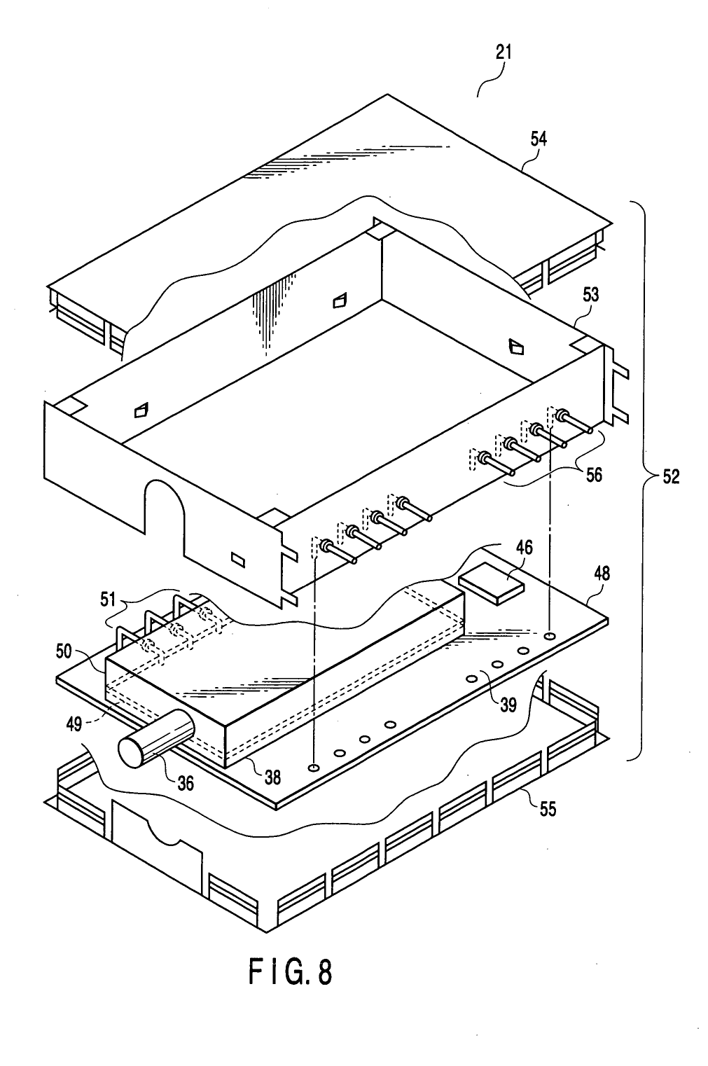

It is to be noted that the terminal group 56 may be arranged over a whole side face of the metal case 53 as shown in FIG. 5 or at a portion of a whole side face as shown in FIG. 7 or 8. Even in this case, the console terminal 47 is included as part of the terminal group 56.

Although in the embodiment above the CATV terminal unit 14 has been explained, by way of example, as an electronic unit with the cable modem module unit 21 incorporated therein, it can be applied as the electronic unit to, for example, a game machine, etc.

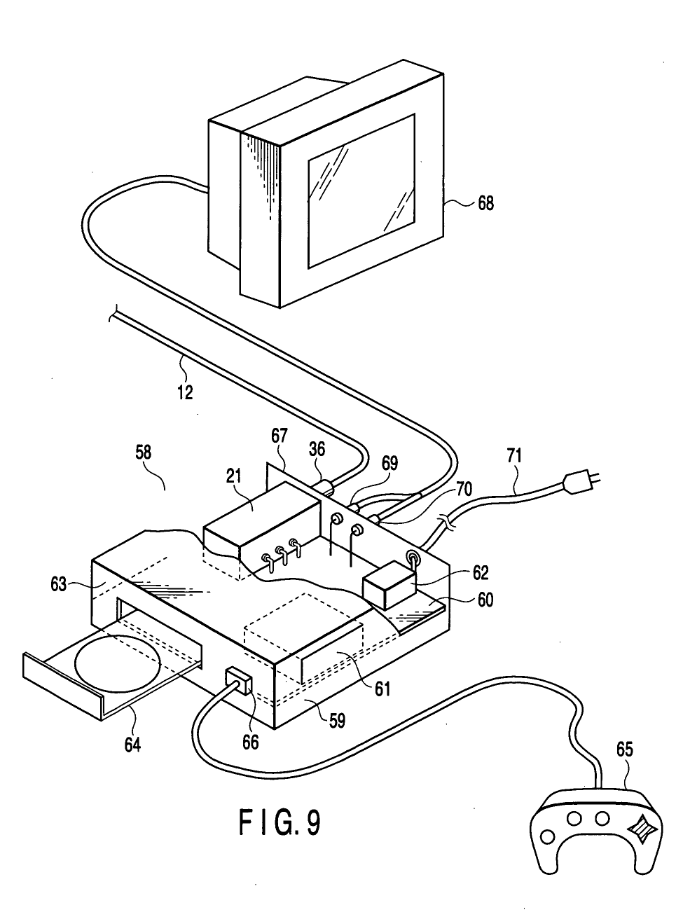

FIG. 9 shows a schematic structure of a game machine 58. This game machine 58 has a substantially box-like housing. Within the housing 59, a main circuit board 60 is held with various kinds of circuit component parts formed thereon.

On the main circuit board 60 are mounted, as main parts, a game data processing chip 61, the abovementioned cable modem module unit 21, and a power supply section 62 for receiving commercial AC power and supplying necessary power to the data processing chip 61 and cable modem module unit 21.

On a front panel 63 of the housing 59 are arranged a disk playback section 64 with a game software-stored disk installed for playback, a connector 66, etc., for the connection of a game controller 65 operated by the user.

On a back panel 67 of the housing 69 are arranged an RF coaxial connector 36 mounted on the cable modem module unit 21, video and audio output terminals 69 and 70 for allowing the video and audio signals which are output from the data processing chip 61 to be delivered as outputs to an external TV receiver 68, etc., and an AC line 71, etc., for supplying commercial AC power to the power supply section 62.

In this game machine 58, unlike the CATV terminal unit 14, the RF coaxial connector 36 of the cable modem module unit 21 is projected from the back panel 67 and connected directly to the CATV cable 12.

The game machine 58 includes, for example, a HDD (Hard Disk Drive) capable of storing a game software, version-up data, high score data, etc., downloadable from the central CATV station 11, and a communication unit, etc., for securing/interrupting communication with any playing opponent in a competitive play type game entered in the central CATV station 11.

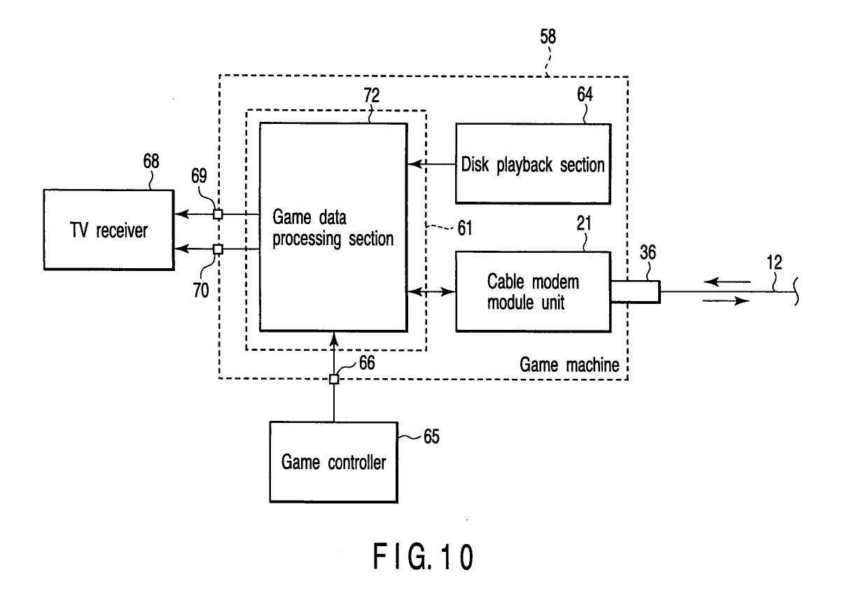

FIG. 10 shows a signal processing system of the above-mentioned game machine 58. That is, a cable modem module unit 21 and disk playback section 64 are connected to a game data processing section 72 in the above-mentioned game data processing chip 61. Further, the game controller 65 is connected through the connector 66 to the game data processing section 72 and a TV receiver 68 is connected through the video and audio output terminals 69 and 70 to the game data processing section 72.

The game data processing section 72 is driven based on a game program played-back at the disk playback section 64 and on a game software, etc., stored in the HDD after having been obtained via the cable modem module unit 21 from the central CATV station 11 and, by doing so, a game content corresponding to the operation of the game controller 65 is audio-visually played back on the TV receiver 68.

Further, the game data processing section 72 transmits various game information items which are formed therein to the central CATV station 11 via the cable modem module unit 21 and receives various kinds of game information items which are transmitted from the central CATV station 11 through the cable modem module unit 21 and, by doing so, a competitive play type game is enjoyed.

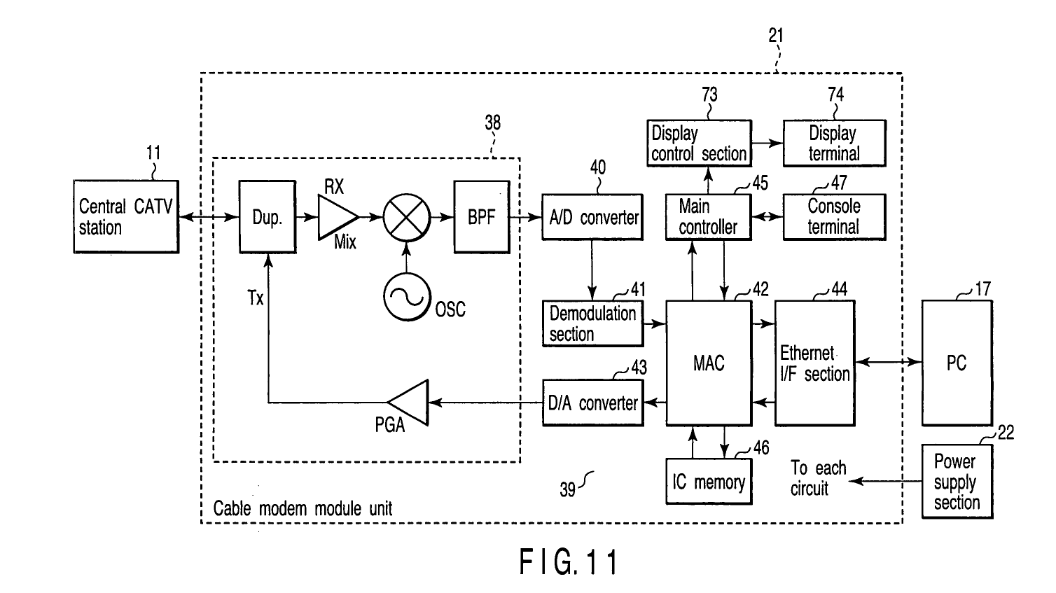

Now, an explanation will be made below about another embodiment. In FIG. 11, the same reference numerals are employed to designate parts or elements corresponding to those shown in FIG. 4. To the abovementioned main controller 45 is connected a display control section 73.

Under the control of the main controller 45, the display control section 73 generates a display control signal for displaying the setting states, operation states, etc., in a cable modem module unit 21, for example, the states of linking to the central CATV station 11, that is, the signal processing states on a circuit board 48 and delivers an output to a display terminal 74.

Here, the display terminal 74 is included as part of a terminal group 56 provided in the metal case 53 above. With the cable modem module unit 21 mounted, for example, on the main circuit board 60 of the game machine 58, a display control signal generated in the display control section 73 can be derived out, through the signal terminal 74, onto a circuit pattern on the main circuit board 60.

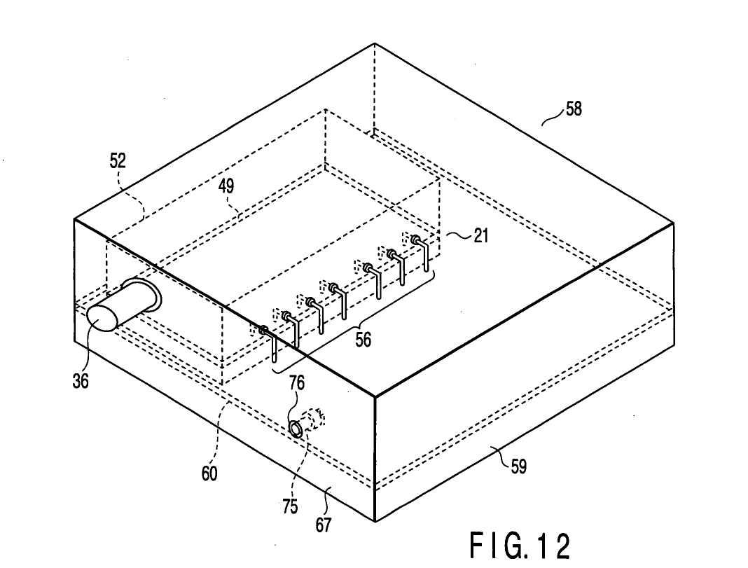

FIG. 12 is a view showing the game machine as seen from its back panel 67 side. That is, the cable modem module unit 21 is mounted on the main circuit board 60 held within the housing 59 such that a terminal group 56 is connected to the cable modem module unit 21. In this case, an RF coaxial connector 36 of the cable modem module unit 21 is inserted through a back panel 67 and projected externally.

Further, a display section 75 formed of, for example, an LED, etc., is mounted at the main circuit board 60. This display section 75 is located in a position corresponding to a window 76 formed on the back panel 67.

The display section 75 is driven based on a display control signal derived out onto a circuit pattern on the main circuit board 60 from a display terminal 74 included in the terminal group 56 of the cable modem module unit 21 and displays the setting states, operation states, etc., in the cable modem module unit 21.

Since the display terminal 74 is included as part of the terminal group 56 and the display control signal for displaying the setting states, operation states, etc., of the cable modem module unit 21 can be derived out onto the circuit pattern on the main circuit board 60, it is possible to drive the display terminal in a state to mount the display section 75 at any position on the main circuit board 60.

For this reason, the display section 75 can be mounted at any position on the housing 59 and this enhances the degree of freedom with which the display section 75 is properly located. As a result, this structure is so constructed as to be properly incorporated into an associated electronic unit.

The present invention should not be restricted directly to the above-mentioned embodiment and various changes or modifications of its constituent elements can be made in any practical stage without departing from the essence of the present invention. Further, various inventions can be achieved by properly combining together a plurality of constituent elements disclosed in the above-mentioned embodiment. For example, a few constituent elements may be eliminated from all the constituent elements shown in the embodiment. Further, those constituent elements according to different embodiments may be properly combined together.

1. A cable modem module unit comprising:
a tuner section configured to have an analog signal processing section for transmitting/receiving a high frequency signal;
a digital signal processing section configured to perform digital processing on the signal input to and output from the tuner section;
a shield case configured to hold the digital signal processing section and tuner section therein; and
a terminal group configured to be connected at one end to the digital signal processing section and, at the other end, inserted into the shield case and extending outwardly to allow a digital signal to be input to, and output from, the digital signal processing section, the terminal group including a first terminal as part of the terminal group to allow a setting or checking to or for the digital signal processing section to be effected from outside the shield case.

2. A cable modem module unit according to claim 1, wherein the first terminal is comprised of a console terminal.

3. A cable modem module unit according to claim 1, wherein the first terminal is connected to a main controller configured to perform overall control of the digital signal processing section.

4. A cable modem module unit according to claim 1, further comprising:
a circuit board configured to form the digital signal processing section;
a display control section configured to generate a display control signal for displaying a signal processing state on the circuit board; and
a second terminal included as part of the terminal group and configured to output a display control signal which is generated at the display control section to an outside of the shield case.

5. A cable modem module unit comprising:
a tuner section configured to have an analog signal processing section for transmitting/receiving a high frequency signal;
a circuit board configured to form a digital signal processing section for performing digital processing on a signal input to, and output from, the tuner section;
a shield case configured to hold, therein, the circuit board together with the tuner section; and
a display control section configured to generate a display control signal for displaying a signal processing state on the circuit board;
a terminal group configured to be connected at one end to the digital signal processing section and, at the other end, inserted into the shield case and extending externally to allow a digital signal to be input to and output from the digital signal processing section, the terminal group including a terminal as part of the terminal group to allow a display control signal which is generated at the display control section to be output to an outside of the shield case.

6. An electronic unit comprising:
a cable modem module unit comprising a tuner section configured to have an analog signal processing section for transmitting/receiving a high frequency signal, a digital signal processing section configured to perform digital processing on a signal input to and output from the tuner section, a shield case configured to hold the digital signal processing section and tuner section therein, and a terminal group configured to be connected at one end to the digital signal processing section and, at the other end, inserted into the shield case and extending outwardly to allow a digital signal to be input to, and output from, the digital signal processing section, the terminal group including a first terminal as part of the terminal group to allow a setting and checking to and for the digital signal processing section to be effected from outside the digital signal processing section; and
a power supply section configured to supply power to the cable modem module unit;
the cable modem module unit is operated with the use of the power from the power supply section.

7. An electronic unit according to claim 6, wherein the first terminal is comprised of a console terminal.

8. An electronic unit according to claim 6, wherein the first terminal is connected to a main controller configured to perform overall control of the digital signal processing section.

9. An electronic unit according to claim 6, wherein the cable modem module unit includes a circuit board configured to form the digital signal processing section thereon, a display control section configured to generate a display control signal for displaying a signal processing state on the printed circuit, and a second terminal included as part of the terminal group and configured to output the display control signal which is output at the display control section to outside the shield case.

10. An electronic unit according to claim 9, further comprising:
a main circuit board configured to mount the cable modem module unit and power supply section thereon;
a display section mounted on the main circuit board and configured to allow a display control signal which is output from a second terminal of the cable modem module unit to be supplied through a circuit pattern formed on the main circuit board; and
a housing configured to hold the main circuit board therein and having a window in a position corresponding to the display section.
